(19) United States
(12) Patent Application Publication
(10) Pub. No.: US 2008/0013410 A1
(43) Pub. Date: Jan. 17, 2008

(54) Wristband pick holder

(76) Inventor: Jordan Malone DuBois, Glendale, AZ (US)

Correspondence Address: Jordan DuBois, 5757 W Beck Lane, Glendale, AZ, 85306, US

(21) Appl. No.: 11/409,533

(22) Filed: Jul. 12, 2006

(51) Int. Cl. G04B 37/00

(52) U.S. Cl. 368/282

(57) ABSTRACT

My invention pertains to music, specifically guitar. It is a wristband designed to hold guitar picks. The cliprings hold the guitar picks in place, so access to a guitar pick is convenient. I used the wristband as the base to hold everything so the invention would be appealing as well as helpful. Having the guitar pick holders on a wristband also allows you to have your guitar picks with you everywhere you go.

The name of this invention is The Wristband Pick Holder. It is a stylish leather wristband with guitar pick holders. The size of the wristband determines the amount of guitar pick holders it contains. Smaller sizes contain three guitar pick holders, while the larger sizes contain four. Wearing the wristband will allow you to always have guitar picks when you need them. It provides a place to put your picks so they do not get lost.

The description of the drawings are as follows:

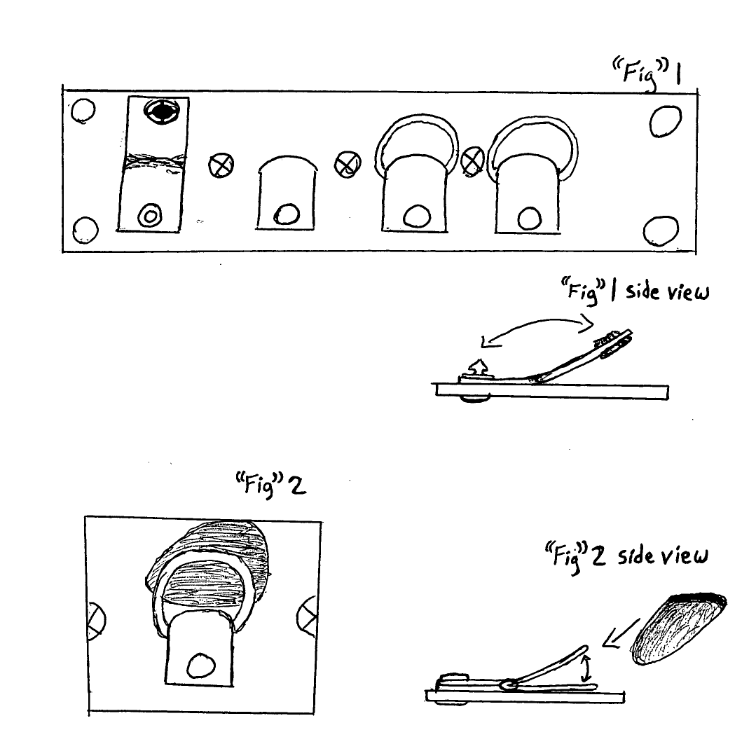

FIG. 1 shows the wristband has leather straps which can open.

FIG. 2 shows the device used to hold the guitar pick, which can open to allow insertion of the guitar pick.

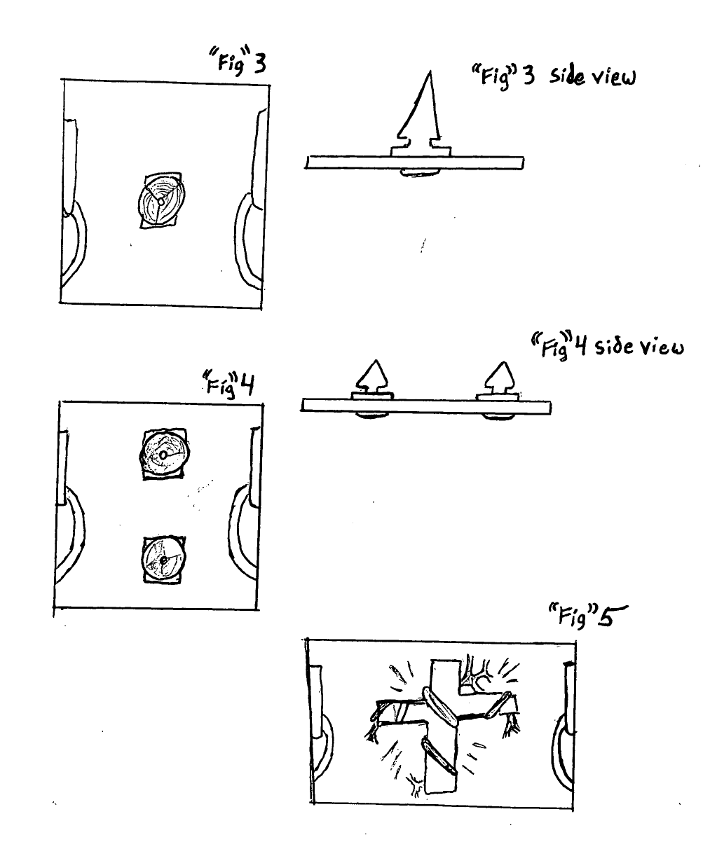

FIGS. 3,4, and 5 all show possible designs which take up space between the leather straps; For looks.

1. I claim a new use for the clampring.
The said new use for the clampring is specifically for holding a guitar pick.
The name of the said clampring, now used for holding a guitar pick, is pick holder.

2. I claim a new design for a wristband.
The said new design for a wristband has said pick holders on it.
